(19) United States
(12) Patent Application Publication
(10) Pub. No.: US 2011/0150467 A1
(43) Pub. Date: Jun. 23, 2011

(54) MULTIPLEXING AND DEMULTIPLEXING APPARATUS AND METHOD OF MULTI-WAVELENGTH OPTICAL SIGNAL

(75) Inventors: Sae-Kyoung KANG, Daejeon (KR); Joon Ki LEE, Daejeon (KR)

(73) Assignee: Electronics and Telecommunications Research Institute, Daejeon (KR)

(21) Appl. No.: 12/888,959

(22) Filed: Sep. 23, 2010

(30) Foreign Application Priority Data
Dec. 18, 2009 (KR) 10-2009-0127224

(51) Int. Cl. H04J 14/00

(52) U.S. Cl. 398/45

(57) ABSTRACT

Provided are a multiplexing and demultiplexing apparatus and method of a multi-wavelength optical signal that may dispose each of thin film filters in a location where a zigzag reflection occurs in a zigzag optical path, and thereby multiplex or demultiplex a multi-wavelength optical signal using the thin film filters. Each of the thin film filters may transmit an optical signal having a predetermined wavelength which is incident at a predetermined incidence angle, and reflect a remaining wavelength optical signal at a predetermined reflection angle.

### CROSS-REFERENCE TO RELATED APPLICATION

This application claims the benefit of Korean Patent Application No. 10-2009-0127224, filed on Dec. 18, 2009, in the Korean Intellectual Property Office, the disclosure of which is incorporated herein by reference.

### BACKGROUND

1. Field of the Invention

The present invention relates to a multiplexing and demultiplexing method and apparatus of a multi-wavelength optical signal in an optical signal transmission apparatus.

2. Description of the Related Art

A Wavelength Division Multiplexing (WDM) scheme used in a WDM optical communication system corresponds to a type of an optical communication scheme that may employ a plurality of channels having various wavelengths as transmission media by multiplexing the plurality of channels to an optical signal, and may detect the optical signal by demultiplexing the multiplexed optical signal to the plurality of channels having various wavelengths. Compared to other types of communication schemes, the WDM scheme may more efficiently expand a communication capacity and transmit data regardless of a type of transmission data. Accordingly, the WDM scheme is widely used for an optical signal transmission apparatus compared to an optical signal transmission scheme using a single channel.

### SUMMARY

An aspect of the present invention provides a multiplexing method and apparatus of a multi-wavelength optical signal.

Another aspect of the present invention also provides a demultiplexing method and apparatus of a multi-wavelength optical signal.

Another aspect of the present invention also provides a multiplexing or demultiplexing method and apparatus of a multi-wavelength optical signal using a plurality of thin film filters. Each of the thin film filters may transmit a predetermined wavelength optical signal that is incident at a predetermined incidence angle, and may reflect, at a predetermined reflection angle, a remaining wavelength optical signal excluding the predetermined wavelength optical signal.

According to an aspect of the present invention, there is provided a multiplexing apparatus, including: a plurality of thin film filters, each transmitting an optical signal having a wavelength predetermined for each thin film filter to output the optical signal to a zigzag optical path when the optical signal is incident at a predetermined incidence angle from a light source; a mirror portion being disposed in a rear end of the zigzag optical path to reflect a multi-wavelength optical signal that is incident along the zigzag optical path and is provided in a collimating form; and a focusing lens optically coupling the reflected multi-wavelength optical signal with an external optical transmission channel.

According to another aspect of the present invention, there is provided a demultiplexing apparatus, including: a collimating lens converting a multi-wavelength optical signal having a predetermined transmission angle to a horizontal optical signal that is a multi-wavelength optical signal provided in a collimating form, to thereby output the horizontal optical signal when the multi-wavelength optical signal having the predetermined transmission angle is received from an external optical transmission channel; a mirror portion being disposed in a front end of a zigzag optical path to reflect the horizontal optical signal output from the collimating lens, and to thereby output the horizontal optical signal to the zigzag optical path; and a plurality of thin film filters, each transmitting an optical signal having a wavelength predetermined for each thin film filter to output the optical signal when the horizontal optical signal is incident at a predetermined incidence angle along the zigzag optical path.

According to still another aspect of the present invention, there is provided a multiplexing method of a multi-wavelength optical signal, including: receiving, from a light source, an optical signal at a predetermined incidence angle; transmitting an optical signal having a wavelength predetermined for each thin film filter to output the optical signal to a zigzag optical path; reflecting, using a mirror portion, the multi-wavelength optical signal that is incident along the zigzag optical path in a rear end of the zigzag optical path and is provided in a collimating form; and optically coupling, using a focusing lens, the reflected multi-wavelength optical signal with an external optical transmission channel.

According to yet another aspect of the present invention, there is provided a demultiplexing method of a multi-wavelength optical signal, including: receiving, from an external optical transmission channel, a multi-wavelength optical signal having a predetermined transmission angle; converting, using a collimating lens, the multi-wavelength optical signal having the predetermined transmission angle to a horizontal optical signal that is a multi-wavelength optical signal provided in a collimating form to thereby output the converted horizontal optical signal; reflecting the horizontal optical signal to output the horizontal optical signal to a zigzag optical path; and transmitting and thereby outputting an optical signal having a wavelength predetermined for each thin film filter when the horizontal optical signal is incident at a predetermined incidence angle along the zigzag optical path.

### EFFECT

According to embodiments of the present invention, there may be provided a method and apparatus for multiplexing or demultiplexing a multi-wavelength optical signal using a plurality of thin film filters that may transmit a predetermined wavelength optical signal incident at a predetermined incidence angle, and may reflect, at a predetermined reflection angle, a remaining wavelength optical signal excluding the predetermined wavelength optical signal. Accordingly, it is possible to decrease a length of a zigzag optical path by disposing each of the thin film filters at a location where a zigzag reflection occurs in the zigzag optical path. In addition, since the length of the zigzag optical path is shortened, it is possible to decrease a loss and an error of an optical signal, and to relatively reduce a size of the apparatus.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of a multiplexing apparatus according to an embodiment of the present invention;

FIG. 2 is a diagram illustrating a configuration of a demultiplexing apparatus according to an embodiment of the present invention;

FIG. 3 is a flowchart illustrating a method of multiplexing, by a multiplexing apparatus, optical signals having various wavelengths to a multi-wavelength optical signal according to an embodiment of the present invention; and

FIG. 4 is a flowchart illustrating a method of demultiplexing, by a demultiplexing apparatus, a multi-wavelength optical signal to optical signals having various wavelengths according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

When it is determined detailed description related to a related known function or configuration they may make the purpose of the present invention unnecessarily ambiguous in describing the present invention, the detailed description will be omitted here.

According to embodiments of the present invention, there may be provided a method and apparatus for multiplexing or demultiplexing a multi-wavelength optical signal using a plurality of thin film filters. Each of the thin film filters may transmit a predetermined wavelength optical signal that is incident at a predetermined incidence angle, and may reflect, at a predetermined reflection angle, a remaining wavelength optical signal excluding the predetermined wavelength optical signal.

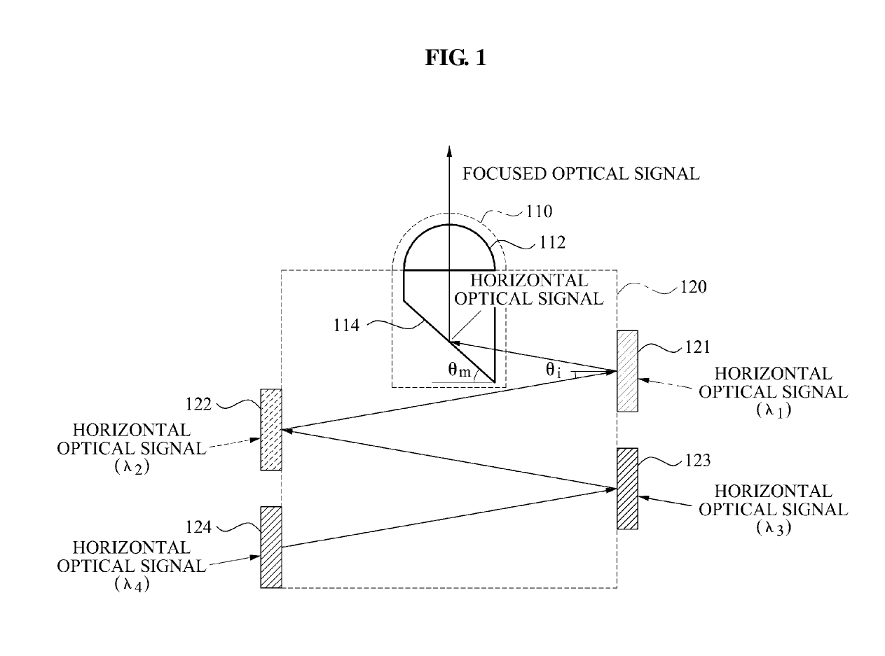

FIG. 1 is a diagram illustrating a configuration of a multiplexing apparatus according to an embodiment of the present invention.

Referring to FIG. 1, the multiplexing apparatus may include a mirror block 110 and an optical path block 120. A focusing lens 112 and a mirror portion 114 may be mounted to the mirror block 110. The optical path block 120 may include a zigzag optical path and a plurality of thin film filters 121, 122, 123, and 124. Each of the thin film filters 121, 122, 123, and 124 is disposed at a location where a zigzag reflection occurs in the zigzag optical path.

When each of optical signal having wavelengths λ₁, λ₂, λ₃, and λ₄ predetermined for the corresponding thin film filters 121, 122, 123, and 124 is incident at a predetermined incidence angle from a light source (not shown), each of the thin film filters 121, 122, 123, and 124 may transmit a corresponding optical signal and output the transmitted optical signal to the zigzag optical path.

When the optical signal is incident along the zigzag optical path, each of the thin film filters 121, 122, 123, and 124 may reflect the incident optical signal to progress along the zigzag optical path.

The mirror portion 114 may be disposed in a rear end of the zigzag optical path to output, to the focusing lens 112, a multi-wavelength optical signal that is incident along the zigzag optical path and is provided in a collimating form. Hereinafter, the multi-wavelength optical signal that is provided in the collimating form is referred to as a horizontal optical signal.

The mirror portion 114 may be mounted to the mirror block 110 at a mirror surface angle θₘ, and may have a relationship with a predetermined incidence angle θᵢ with respect to the thin film filters 121, 122, 123, and 124. The relationship may be represented by the following Equation 1.

θᵢ=2*θₘ−90° [Equation 1]

Each of the mirror surface angle θₘ and the predetermined incidence angle θᵢ may correspond to an angle based on a vertical line of a corresponding thin film filter.

To optically couple the horizontal optical signal received from the mirror portion 114 with an external optical transmission channel, the focusing lens 112 may convert the horizontal optical signal to a multi-wavelength optical signal having a predetermined transmission angle through focusing. Hereinafter, the multi-wavelength optical signal having the predetermined transmission angle is referred to as a focused optical signal.

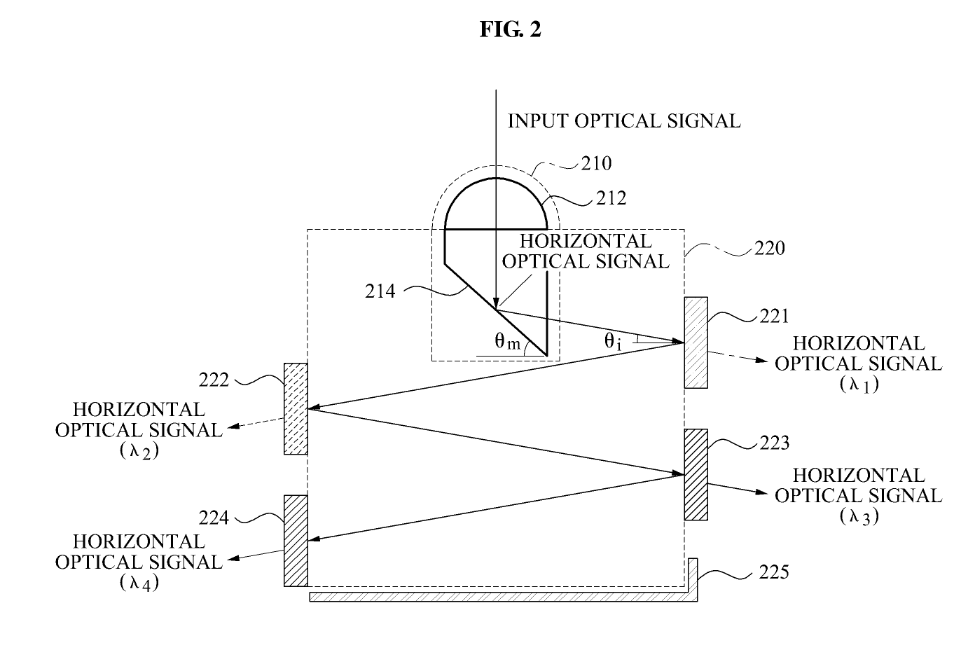

FIG. 2 is a diagram illustrating a configuration of a demultiplexing apparatus according to an embodiment of the present invention.

Referring to FIG. 2, the demultiplexing apparatus may include a mirror block 210 and an optical path block 220. A collimating lens 212 and a mirror portion 214 may be mounted to the mirror block 210. The optical path block 220 may include a zigzag optical path, and may include a plurality of thin film filters 221, 222, 223, and 224 and a light absorption portion 225. Each of the thin film filters 221, 222, 223, and 224 is disposed at a location where a zigzag reflection occurs in the zigzag optical path.

When an input optical signal having a predetermined transmission angle is received from an external optical transmission channel, the collimating lens 212 may convert the input optical signal to a horizontal optical signal and output the horizontal optical signal to the mirror portion 214.

The mirror portion 214 may be disposed in a front end of the zigzag optical path to reflect the horizontal optical signal received from the collimating lens 212, and to thereby output the horizontal optical signal to the thin film filter 221 corresponding to a first thin film filter among the thin film filters 221, 222, 223, and 224 along the zigzag optical path.

The mirror portion 214 may be mounted to the mirror block 210 at a mirror surface angle θₘ and may have a relationship with a predetermined incidence angle θᵢ with respect to the thin film filters 221, 222, 223, and 224. The relationship may be represented by the following Equation 2.

θᵢ=2*θₘ−90° [Equation 2]

Each of the mirror surface angle θₘ and the predetermined incidence angle θᵢ may correspond to an angle based on a vertical line of a corresponding thin film filter.

When the horizontal optical signal is incident at a predetermined incidence angle along the zigzag optical path, each of the thin film filters 221, 222, 223, and 224 may transmit a predetermined wavelength optical signal and output the predetermined wavelength optical signal to a light receiving portion (not shown) of the optical path block 220.

Each of the thin film filters 221, 222, 223, and 224 may reflect a remaining wavelength optical signal excluding the transmitted predetermined wavelength optical signal in the horizontal optical signal, to progress along the zigzag optical path.

For noise cancellation, the light absorption portion 225 may be disposed in a rear end of the zigzag optical path to absorb the remaining optical signal having passed through all the thin film filters 221, 222, 223, and 224 existing in the zigzag optical path.

Hereinafter, a method of multiplexing optical signals having various wavelengths or demultiplexing a multi-path optical signal according to an embodiment of the present invention will be described.

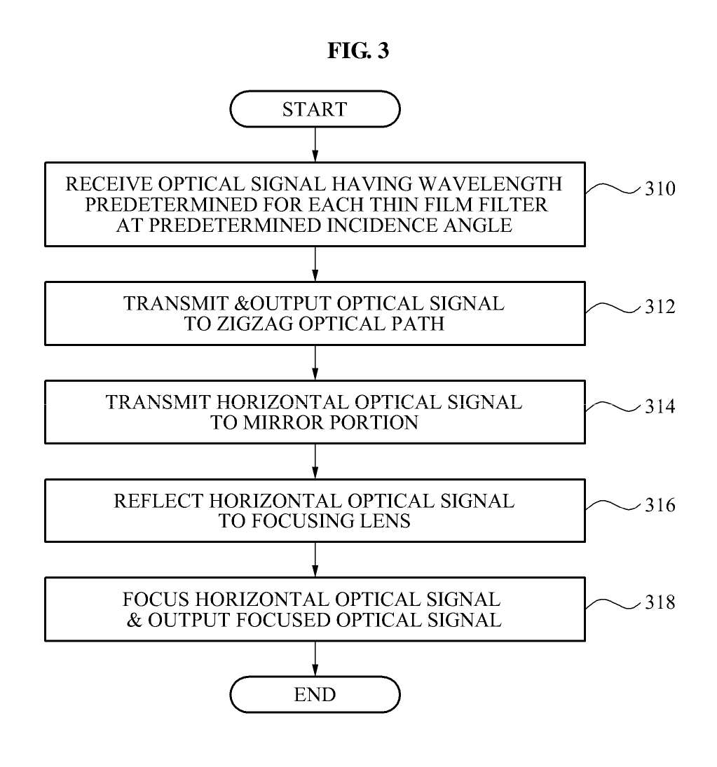

FIG. 3 is a flowchart illustrating a method of multiplexing, by a multiplexing apparatus, optical signals having various wavelengths to a multi-wavelength optical signal according to an embodiment of the present invention.

In operation 310, the multiplexing apparatus may receive an optical signal having a wavelength predetermined for each thin film filter at a predetermined incidence angle. In operation 312, the multiplexing apparatus may transmit the optical signal via each thin film filter and thereby output the optical signal to a zigzag optical path.

In operation 314, the multiplexing apparatus may transmit a horizontal optical signal to a mirror portion disposed in a rear end of the zigzag optical path, along the zigzag optical path. Here, the horizontal optical signal may include optical signals having various wavelengths.

In operation 316, the multiplexing apparatus may reflect the horizontal optical signal to a focusing lens.

In operation 318, to optically couple the horizontal optical signal with an external optical transmission channel, the multiplexing apparatus may focus, using the focusing lens, the horizontal optical signal and thereby convert the horizontal optical signal to a focused optical signal and output the converted focused optical signal to an external optical transmission channel.

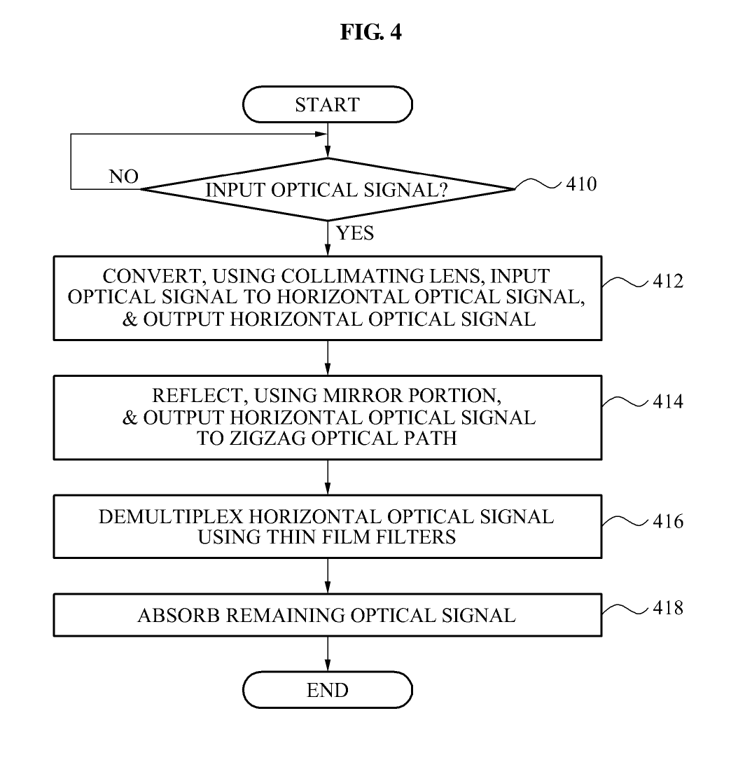

FIG. 4 is a flowchart illustrating a method of demultiplexing, by a demultiplexing apparatus, a multi-wavelength optical signal to optical signals having various wavelengths according to an embodiment of the present invention.

Referring to FIG. 4, when an input optical signal is received from an external optical transmission channel in operation 410, the demultiplexing apparatus may convert the input optical signal to a horizontal optical signal using a collimating lens and thereby output the converted horizontal optical signal to a mirror portion in operation 412.

In operation 414, the demultiplexing apparatus may reflect the horizontal optical signal using the mirror portion and thereby output the horizontal optical signal to a zigzag optical path.

In operation 416, the demultiplexing apparatus may demultiplex the horizontal optical signal using thin film filters disposed in the zigzag optical path. Here, demultiplexing indicates an optical signal having a wavelength predetermined for each thin film filter and thereby outputting a predetermined wavelength optical signal when the optical signal having the wavelength predetermined for each thin film filter is incident into a corresponding thin film filter at a predetermined incidence angle. When an optical signal having an un-predetermined remaining wavelength is incident at the predetermined incidence angle along the zigzag optical path, the demultiplexing apparatus may reflect the remaining wavelength optical signal to progress along the zigzag optical path.

In operation 418, the demultiplexing apparatus may absorb, using a light absorption portion, the remaining wavelength optical signal having passed through all the thin film filters existing in the zigzag optical path.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A multiplexing apparatus, comprising:
a plurality of thin film filters, each transmitting an optical signal having a wavelength predetermined for each thin film filter to output the optical signal to a zigzag optical path when the optical signal is incident at a predetermined incidence angle from a light source;
a mirror portion being disposed in a rear end of the zigzag optical path to reflect a multi-wavelength optical signal that is incident along the zigzag optical path and is provided in a collimating form; and
a focusing lens optically coupling the reflected multi-wavelength optical signal with an external optical transmission channel.

2. The multiplexing apparatus of claim 1, wherein when the optical signal is incident along the zigzag optical path, each of the thin film filters reflects the incident optical signal to progress along the zigzag optical path.

3. The multiplexing apparatus of claim 1, wherein each of the thin film filters is disposed at a location where a zigzag reflection occurs in the zigzag optical path.

4. The multiplexing apparatus of claim 1, wherein:
the predetermined incidence angle corresponds to an angle obtained by subtracting 90 degrees from a result of doubling a mirror surface angle of the mirror portion, and
each of the predetermined incidence angle and the mirror surface angle is measured based on a vertical line of a corresponding thin film filter.

5. A demultiplexing apparatus, comprising:
a collimating lens converting a multi-wavelength optical signal having a predetermined transmission angle to a horizontal optical signal that is a multi-wavelength optical signal provided in a collimating form, to thereby output the horizontal optical signal when the multi-wavelength optical signal having the predetermined transmission angle is received from an external optical transmission channel;
a mirror portion being disposed in a front end of a zigzag optical path to reflect the horizontal optical signal output from the collimating lens, and to thereby output the horizontal optical signal to the zigzag optical path; and
a plurality of thin film filters, each transmitting an optical signal having a wavelength predetermined for each thin film filter to output the optical signal when the horizontal optical signal is incident at a predetermined incidence angle along the zigzag optical path.

6. The demultiplexing apparatus of claim 5, wherein each of the thin film filters reflects a remaining wavelength optical signal excluding the predetermined wavelength optical signal in the horizontal optical signal, to progress along the zigzag optical path.

7. The demultiplexing apparatus of claim 5, wherein each of the thin film filters is disposed at a location where a zigzag reflection occurs in the zigzag optical path.

8. The demultiplexing apparatus of claim 5, wherein:
the predetermined incidence angle corresponds to an angle obtained by subtracting 90 degrees from a result of doubling a mirror surface angle of the mirror portion, and
each of the predetermined incidence angle and the mirror surface angle is measured based on a vertical line of a corresponding thin film filter.

9. The demultiplexing apparatus of claim 5, further comprising:
a light absorption portion being disposed in a rear end of the zigzag optical path to absorb an un-demultiplexed optical signal having passed through all the thin film filters existing in the zigzag optical path.

10. A multiplexing method of a multi-wavelength optical signal, comprising:
receiving, from a light source, an optical signal at a predetermined incidence angle;
transmitting an optical signal having a wavelength predetermined for each thin film filter to output the optical signal to a zigzag optical path;
reflecting, using a mirror portion, the multi-wavelength optical signal that is incident along the zigzag optical path in a rear end of the zigzag optical path and is provided in a collimating form; and
optically coupling, using a focusing lens, the reflected multi-wavelength optical signal with an external optical transmission channel.

11. The method of claim 10, wherein when the optical signal is incident along the zigzag optical path, each of the thin film filters reflects the incident optical signal to progress along the zigzag optical path.

12. The method of claim 10, wherein each of the thin film filters is disposed at a location where a zigzag reflection occurs in the zigzag optical path.

13. The method of claim 10, wherein:
the predetermined incidence angle corresponds to an angle obtained by subtracting 90 degrees from a result of doubling a mirror surface angle of the mirror portion, and
each of the predetermined incidence angle and the mirror surface angle is measured based on a vertical line of a corresponding thin film filter.

14. A demultiplexing method of a multi-wavelength optical signal, comprising:
receiving, from an external optical transmission channel, a multi-wavelength optical signal having a predetermined transmission angle;
converting, using a collimating lens, the multi-wavelength optical signal having the predetermined transmission angle to a horizontal optical signal that is a multi-wavelength optical signal provided in a collimating form to thereby output the converted horizontal optical signal;
reflecting the horizontal optical signal to output the horizontal optical signal to a zigzag optical path; and
transmitting and thereby outputting an optical signal having a wavelength predetermined for each thin film filter when the horizontal optical signal is incident at a predetermined incidence angle along the zigzag optical path.

15. The method of claim 14, wherein each of the thin film filters reflects a remaining wavelength optical signal excluding the predetermined wavelength optical signal in the horizontal optical signal, to progress along the zigzag optical path.

16. The method of claim 14, wherein each of the thin film filters is disposed at a location where a zigzag reflection occurs in the zigzag optical path.

17. The method of claim 14, wherein:
the predetermined incidence angle corresponds to an angle obtained by subtracting 90 degrees from a result angle of doubling a mirror surface angle of the mirror portion, and
each of the predetermined incidence angle and the mirror surface angle is measured based on a vertical line of a corresponding thin film filter.

18. The method of claim 14, further comprising:
absorbing an un-demultiplexed optical signal having passed through all the thin film filters in a rear end of the zigzag optical path.
